(19) United States
(12) Patent Application Publication
(10) Pub. No.: US 2006/0062572 A1
(43) Pub. Date: Mar. 23, 2006

(54) Image reading apparatus

(75) Inventor: Yasunobu Sakaguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/206,269

(22) Filed: Aug. 18, 2005

(30) Foreign Application Priority Data
Aug. 18, 2004 (JP) 2004-238611

(51) Int. Cl. G03D 13/04

(52) U.S. Cl. 396/639

(57) ABSTRACT

An automatic focusing (AF) control section performs focus detection for each of focusing regions provided in an image reading area to detect positions of an image-forming lens where the focusing regions are focused as partial focusing positions. A loading condition judgment unit judges the loading condition of a photographic film by inspecting a curl of the image reading area based on each of the partial focusing positions. When the image reading area is bowed such that the center thereof is projected toward an area CCD, the photographic film is judged being loaded in reverse, and a warning message is displayed on a display. In this case, image reading of the photographic film is not executed.

### BACKGROUND OF THE INVENTION

1. Field of the Invention

The present invention relates to an image reading apparatus for reading an image from an original being loaded in a film carrier.

2. Description Related to the Prior Art

Image reading apparatuses that read an image recorded on an original, by forming an optical image on a photoreceptive surface of a photoelectric converter such as a charge coupled device (hereinafter referred to as the CCD) image sensor and the like, are known. A film scanner is one of the image reading apparatuses and reads photographic films as the originals (U.S. Pat. No. 6,816,287). One side of a base of the photographic film is coated with emulsion, and the emulsion-coated side is a front surface (reading side) of the photographic film on which the image is recorded. The photographic film is loaded in a film carrier of the film scanner such that the front surface faces to the photoreceptive surface of the CCD. A rear side of the photographic film loaded in the film carrier is illuminated, and the light transmitted through the photographic film is focused on the photoreceptive surface of the CCD by an image-forming lens.

If the photographic film is not loaded in the film carrier properly, with the front surface facing the photoreceptive surface of the CCD, a reversed image is read from the photographic film. When the read reversed image is printed, a so-called reversed printing is produced. To prevent this, the operator conventionally has to make a visual check of the photographic film to distinguish the front surface from the rear surface before loading it in the film carrier.

However, it is time consuming to distinguish the front surface from the rear surface by the visual check. Further, it is difficult to distinguish between the front and rear surfaces of the transparent originals like the photographic film. Additionally, even if the transparent original is loaded in reverse, the reversed image can be printed with little degradation of the image quality. Therefore, there is a possibility of not noticing that the image has been reversed in the printing even after looking at printed photographs.

### SUMMARY OF THE INVENTION

A primary object of the present invention is to provide an image reading apparatus that can automatically distinguish between front and rear surfaces of an original.

Another object of the present invention is to provide an image reading apparatus that prevents image reading from the original being loaded in reverse.

Originals may curl due to the characteristic differences between their front and rear surfaces. For instance, photographic films tend to curl toward a front surface, which is coated with emulsion, since the emulsion contracts more than a base. The present invention is to distinguish between the front and rear surfaces of the original by inspecting the curl of the original.

In order to achieve the above and other objects, the image reading apparatus of the present invention comprises a partial focusing position detector, and a loading condition judgment unit that distinguishes between the front and rear surfaces of the original. Focusing of an image-forming lens is performed after an original is set in a reading station, in order to form a sharp optical image from the original on a photoreceptive surface of a photoelectric converter. For the sake of the focusing, plural focusing regions are provided in an image reading area, which is for reading the image from the original, for multi-point measurement. The partial focusing position detector performs focusing for each of the focusing regions to detect partial focusing positions. The partial focusing positions are the positions of the image-forming lens where focal points for each of the focusing regions coincide with the photoreceptive surface of the photoelectric converter, which is used for reading the image from the original. The loading condition judgment unit judges whether the original is loaded in the film carrier properly, with the front surface (reading side) facing the photoreceptive surface, by inspecting curl of the photographic film based on the detected partial focusing positions. The loading condition judgment unit stops image reading when it judges the original being loaded in reverse.

It is possible that the image reading apparatus further comprises an annunciator that gives warning when the loading condition judgment unit judges the original not being loaded in the film carrier properly. The annunciator displays a warning message on a display, or sounds a beep or voice as a warning. Further, it is preferable that the loading condition judgment unit judges the original being loaded properly when the image reading area is bowed such that the center thereof is concave downward from a side of the photoreceptive surface, whereas the loading condition judgment unit judges the original not being loaded properly when the image reading area is bowed such that the center thereof projects toward the photoreceptive surface.

Moreover, it is preferable that the focusing regions include at least three regions that are a center region of the image reading area and a pair of edge regions that are symmetric with respect to the center region and being located at opposite corners of the image reading area. The arrangement of the edge regions especially allows to keep long distance between two focusing regions.

According to the present invention, the image reading apparatus detects the partial focusing positions, which are positions of the image-forming lens at which the focusing regions are respectively focused. The image reading apparatus then automatically judges whether the original is loaded in the film carrier properly or not by inspecting the curl of the original based on the partial focusing positions. Therefore, the image reading apparatus of the present invention improves operational efficiency in loading the original in the film carrier. In addition, the image reading apparatus of the present invention prevents the image reading from the original being loaded in reverse by giving warning when the original is not loaded properly.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a digital print system;

FIG. 2 is a schematic diagram of an area CCD scanner;

FIG. 3 is an explanatory illustration showing focusing regions;

FIG. 4 is a flow chart showing a process for judging loading condition;

FIG. 5A is an explanatory illustration showing a photographic film being loaded in a conveying passage properly, FIG. 5B is an explanatory illustration showing the photographic film being loaded in the conveying passage in reverse; and

FIG. 6 is an explanatory illustration showing a warning message being displayed on a display.

### PREFERRED EMBODIMENTS OF THE INVENTION

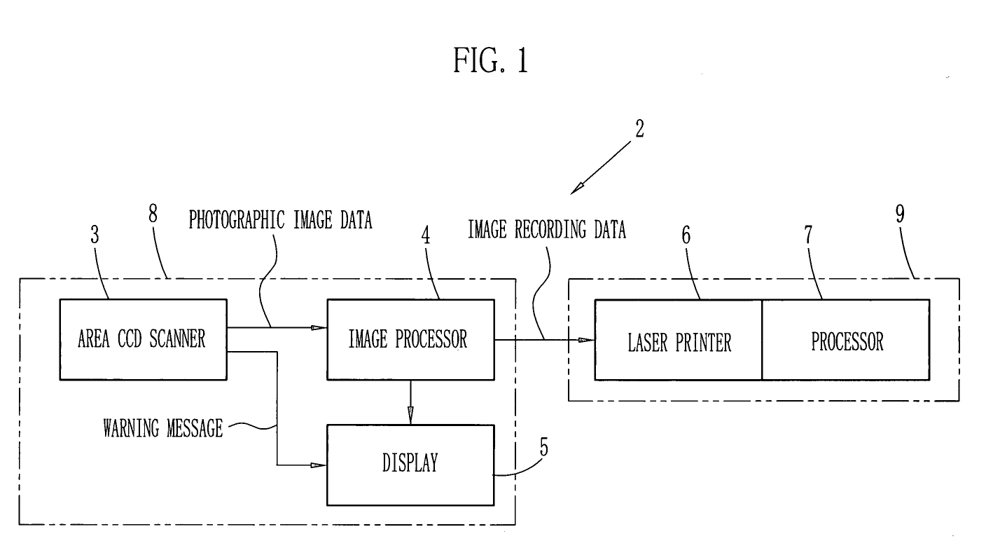

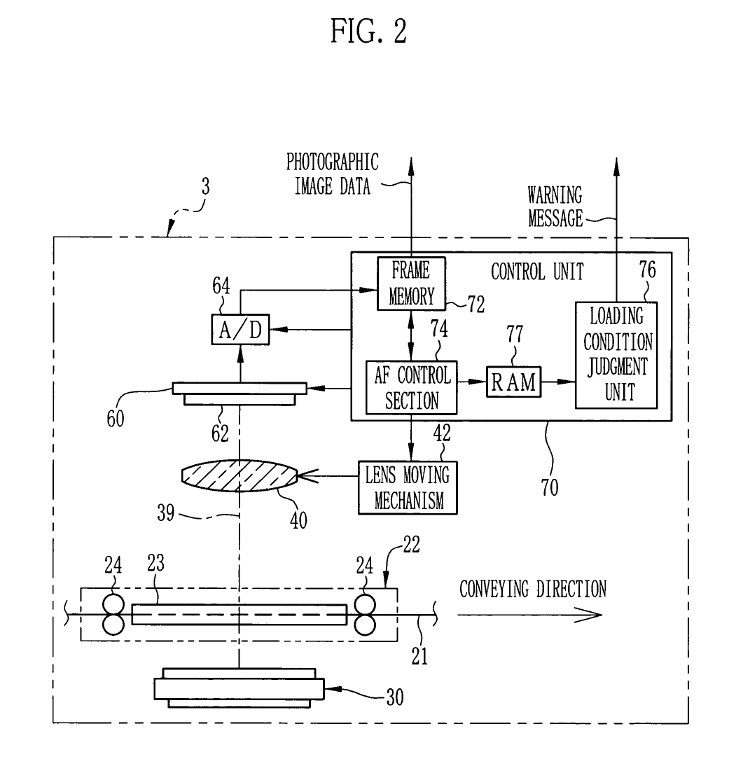

A digital print system 2 shown in FIG. 1 is constituted of an input apparatus 8 and an output apparatus 9. The input apparatus 8 includes an area CCD scanner 3, an image processor 4 and a display 5, and reads an image of each frame of a photographic film 21 (see FIG. 2), which is an original to be read. The output apparatus 9 includes a laser printer 6 and a processor 7, and prints the read image of the each frame of the photographic film 21 on a recording medium.

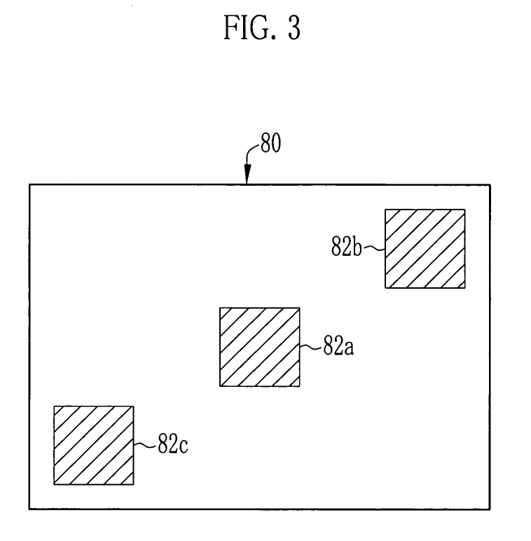

The area CCD scanner 3 reads the photographic image of the each frame of the photographic film 21 that resides in an image reading area 80 (see FIG. 3). Image signals of analog outputted from the area CCD scanner 3 are digitized by an analog-digital (A/D) converter 64 to be photographic image data, then the photographic image data is sent to the image processor 4. The image processor 4 performs various image processing procedures, including density correction, color correction, sharpness control and so forth, on the photographic image data. The processed photographic image data is converted into image recording data and sent to the laser printer 6.

As well known, the laser printer 6 comprises a laser exposure unit, which includes laser-beam sources of red (R), green (G) and blue (B), a polygon mirror, an fθ lens, a reflection mirror, and so on. The laser printer 6 records a latent image on a color paper, based on the image recording data. The processor 7 executes a developing process on the recorded color paper.

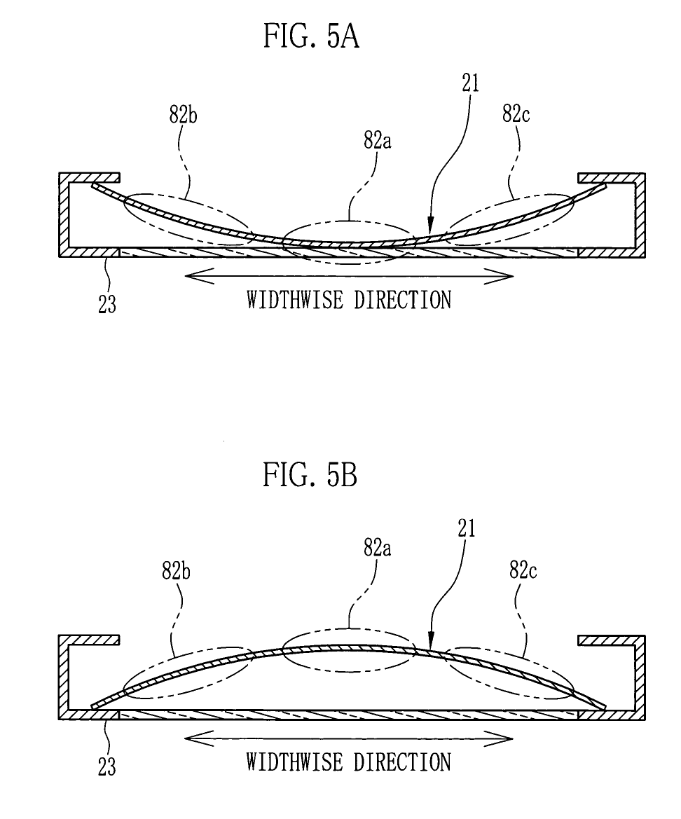

In FIG. 2, the photographic film 21 is placed in a film carrier 22. The film carrier 22 is provided with a conveying passage 23 and plural transport roller pairs 24. The conveying passage 23 is formed to have a channel section at opposite ends along its widthwise direction (see FIG. 5). One side of a base of the photographic film 21 is coated with emulsion, and the emulsion-coated side is a front surface of the photographic film on which the image is recorded. The photographic film 21 is sent to the conveying passage 23 with the front surface up. The transport roller pair 24 consists of an upper roller and a lower roller that nip the photographic film 21 in-between. The transport roller pairs 24 are placed at positions upstream and downstream from the conveying passage 23, respectively. The transport roller pairs 24 nip and convey the photographic film 21.

Below the film carrier 22 is a LED unit 30 for illuminating the photographic film 21. The LED unit 30 uses four kinds of LEDs, which are a red LED for emitting red light, a green LED for emitting green light, a blue LED for emitting blue light and an infrared LED for emitting infrared rays, and these four kinds of LEDs are arranged in a mosaic pattern. Firstly, focusing of the image-forming lens is performed after the image frame of the photographic film 21 is set in a reading station of the film carrier 22. In the focusing, the red, green and blue LEDs are turned on simultaneously to compose white light for illuminating the image frame. Secondly, the infrared LEDs are turned on to detect the existence and positions of dusts, scratches or the like on the photographic film 21. Lastly, the red, green and blue LEDs are turned on sequentially one color to another to obtain image data of the respective RGB colors.

Above the film carrier 22 are an image-forming lens 40 and a monochrome area CCD 60 arranged sequentially along an optical axis 39. The image-forming lens 40 is moved up and down by a lens moving mechanism 42 having a stepping motor, to change focal positions. The focusing is performed by the movement of the image-forming lens 40 along the optical axis 39. The light of respective colors emitted from the LED unit 30 and transmitted through the photographic film 21 is received on a photoreceptive surface 62 of the area CCD 60. Note that the area CCD may be a color area CCD. When the color area CCD is used, a three-color image can be obtained while the photographic film 21 is being illuminated with white light.

As well known, a large number of photoelectric conversion elements, which correspond to pixels, are arranged on the photoreceptive surface 62 of the area CCD 60. The area CCD 60 photoelectrically converts the light transmitted through the photographic film 21 to image signals. The area CCD 60 outputs low-resolution image signals in the focusing, whereas it outputs full-resolution image signals in sending the image data to the image processor 4. The analog image signals outputted from the area CCD 60 are sent to the A/D converter 64. The A/D converter 64 converts the analog image signals into digital image data, and outputs this digital image data to a control unit 70. According to the preferred embodiment, the area CCD is used. However, it is possible to use a line CCD when the image is read line by line, while the photographic film is being transported.

The control unit 70 performs overall-control of the area CCD scanner 3. The control unit 70 controls every part of the area CCD scanner 3 according to operation signals inputted from an operation member (not-shown), such as a keyboard or a mouse, of the input apparatus 8. The control unit 70 also displays a warning message on the display 5 when the photographic film 21 is judged being loaded in reverse.

The control unit 70 comprises a frame memory 72, an automatic focusing (AF) control section 74 and a loading condition judgment unit 76. The frame memory 72 is a work memory for temporarily storing the image data outputted from the A/D converter 64. After being stored in the frame memory 72, the full-resolution image data is sent to the image processor 4 as photographic image data, whereas the low-resolution image data is used for the focusing.

The AF control section 74 performs focusing by controlling the lens moving mechanism 42. In the focusing, the distance from the area CCD 60 to each point of the image reading area 80, in which the image to be read by the CCD resides, on the photographic film 21 differs from point to point when the photographic film 21 is curled. In this case, for instance, if a center of the image reading area 80 is focused with the image-forming lens 40, other areas of the image reading area 80 are defocused.

Accordingly, plural regions to be focused (hereinafter referred to as the focusing regions) are provided in the image reading area 80. The area CCD scanner 3 adopts multi-point AF system, wherein the area CCD scanner 3 detects positions of the image-forming lens 40 at which the focusing regions are respectively focused (partial focusing positions), and performs the focusing of the image with reference to these partial focusing positions.

The photographic film 21 tends to curl toward the front surface since the emulsion contracts more than the base. Therefore, it is possible to distinguish between front and rear surfaces of the photographic film 21 by inspecting the curl of the photographic film 21. According to the present embodiment, three focusing regions are provided in the image reading area 80 on the photographic film 21, as shown in FIG. 3. They are a center focusing region 82a and a pair of edge focusing regions 82b and 82c. These edge focusing regions 82b and 82c are symmetric with respect to the center region 82a and being located at opposite corners of the image reading area 80.

The AF control section 74 picks up the image from the image frame being illuminated with white light, while moving the image-forming lens 40 along the optical axis 39. The AF control section 74 examines variations in contrast value at each position of the image-forming lens 40 for each of the focusing regions 82a to 82c. The AF control section 74 then detects positions of the image-forming lens 40 at which each of the focusing regions 82a to 82c has a maximum contrast value. These positions are partial focusing positions at which the focusing regions 82a to 82c are respectively focused. Each of the detected partial focusing positions is recorded in a RAM 77.

The AF control section 74 moves the image-forming lens 40 to a midpoint between the partial focusing position closest to the photographic film 21 and the partial focusing position closest to the area CCD 60 (the midpoint between maximum and minimum values of the partial focusing positions), among all of the detected partial focusing positions. In this way, the focusing is completed. A difference between the maximum and minimum values of the partial focusing positions corresponds to a curl amount of the photographic film 21. By moving the image-forming lens 40 to a position where a midpoint of the curl amount is focused, the whole image reading area 80 is focused.

The loading condition judgment unit 76 distinguishes the front surface from the rear surface of the photographic film 21 based on the partial focusing positions detected during the focusing, and judges whether the photographic film 21 is loaded properly, with the front surface facing the photoreceptive surface 62, or not. As stated above, the loading condition judgment unit 76 can judge the loading condition of the photographic film 21 by inspecting the curl of the photographic film 21.

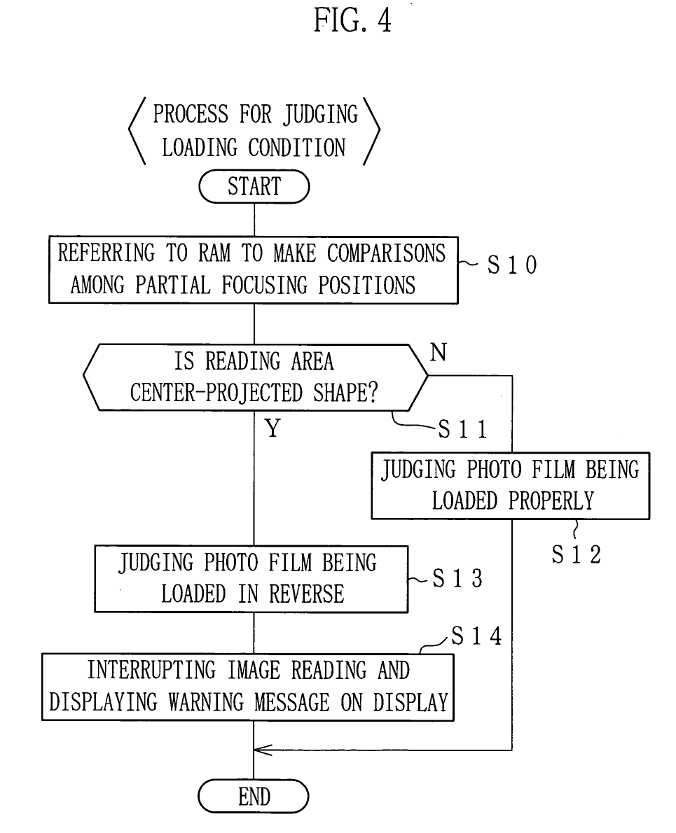

Hereinafter, a process for judging the loading condition is specifically described with reference to a flow chart shown in FIG. 4. The loading condition judgment unit 76 refers to the RAM 77 to make comparisons among partial focusing positions (S10). Each of the partial focusing positions corresponds to the distance from the photoreceptive surface 62 to the photographic film 21 on each of the focusing regions 82a to 82c. Therefore, distance relations between the photographic film 21 on each of the focusing regions 82a to 82c to the photoreceptive surface 62 can be recognized by making comparisons among the partial focusing positions.

The loading condition judgment unit 76 inspects whether the image reading area 80 is bowed such that the center thereof is concave downward from a side of the photoreceptive surface 62, as shown in FIG. 5A (center-recessed shape) or is bowed such that the center thereof projects toward the photoreceptive surface 62, as shown in FIG. 5B (center-projected shape) (S11). The loading condition judgment unit 76 determines that the image reading area 80 is the center-recessed shape when the distance from the photoreceptive surface 62 to the photographic film 21 on the focusing region 82a is longest among all of the focusing regions 82a to 82c. On the other hand, the loading condition judgment unit 76 determines that the image reading area 80 is the center-projected shape when the distance from the photoreceptive surface 62 to the photographic film 21 on the focusing region 82a is shortest among all of the focusing regions 82a to 82c.

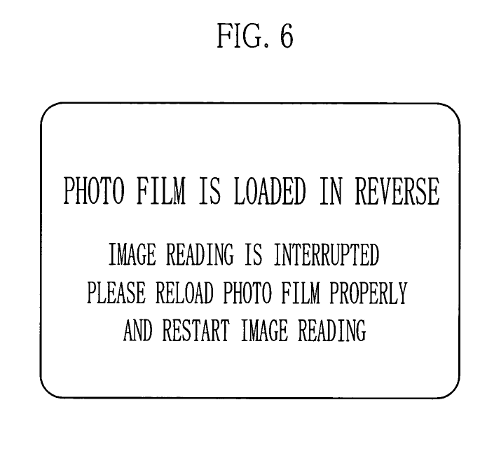

When the image reading area 80 is the center-recessed shape, the loading condition judgment unit 76 judges the photographic film 21 being loaded properly, with the front surface facing the photoreceptive surface 62 (S12). On the other hand, when the image reading area 80 is the center-projected shape, the loading condition judgment unit 76 judges the photographic film 21 being loaded in reverse, with the rear surface facing the photoreceptive surface 62 (S13). In this case, the loading condition judgment unit 76 displays the warning message, as shown in FIG. 6, on the display 5 without executing the image reading operation (S14).

Hereinafter, an operation of the present invention according to the above configuration is described. The photographic film 21 is loaded in the film carrier 22 for printing the image recorded on the photographic film 21. After the photographic film 21 is loaded, an instruction for reading the image is inputted through the keyboard or the mouse that are connected to the area CCD scanner 3, thereby initiating the focusing.

In the focusing, positions of the image-forming lens 40, at which the focusing regions 82a to 82c of the image reading area 80 are respectively focused (partial focusing positions), are detected based on the contrast values of the image data obtained while moving the image-forming lens 40. Then, the midpoint between the partial focusing position closest to the photographic film 21 and the partial focusing position closest to the area CCD 60 is obtained, and the image-forming lens 40 is moved to this midpoint.

After the completion of the focusing, the loading condition of the photographic film 21 is judged. The loading condition is judged by inspecting the curl of the image reading area 80 based on the partial focusing positions detected during the focusing. When the image reading area 80 is the center-recessed shape, the photographic film 21 is judged being loaded properly, and then the image data of the respective RGB colors are obtained from one color to another.

On the other hand, when the image reading area 80 is the center-projected shape, the photographic film 21 is judged being loaded in reverse. In this case, the loading condition judgment unit 76 displays the warning message on the display 5 without executing image reading operation. When the warning message is displayed, the operator turns the photographic film 21 over and places the photographic film 21 in the film carrier 22, and then inputs the instruction for reading the image again.

Thus, the area CCD scanner 3 according to the present invention automatically judges whether the photographic film 21 is loaded properly or not, and displays the warning message for informing that the photographic film 21 is loaded in reverse. For this configuration, the image reading from the photographic film 21 being loaded in reverse can be prevented.

Note that the above embodiment is described on the precondition that the photographic film tends to curl toward the front surface being coated with emulsion since the emulsion contracts more than the base. However, this tendency is possibly reversed as humidity increases since the emulsion expands more than the base under high humidity conditions. In this case, the image reading may be performed even with the photographic film being loaded in reverse. To prevent this, it is possible to provide a humidity sensor so that the loading condition judgment unit 76 judges the photographic film being loaded in reverse when the image reading area is the center-recessed shape under the condition that the humidity is higher than the predetermined level. It is also possible to take other conditions, such as temperature and the like, into consideration in judging the loading condition of the photographic film.

According to the present invention, besides the photographic film, other types of originals, which curl due to the characteristic differences between their front and rear surfaces, can be distinguished the front surface from the rear surface by inspecting the curl of the originals. The image reading apparatus, which illuminates the transparent original from the rear side thereof, is explained as an example in the above embodiment. However, the present invention may be applied to other image reading apparatuses, such as a reflective scanner, which illuminates the original from the front side thereof.

In the above embodiment, three regions, which are the center region of the image reading area and a pair of the edge regions that are located at opposite corners of the image reading area, are designated as focusing regions. However, the present invention is not limited to this. The positions, sizes or shapes of the focusing regions can be designated without restraint. In addition, the number of the focusing regions can be designated freely as long as it is more than two. The tendency of the curl differs depending on the kind of the original. Therefore, the focusing regions should be designated in accordance with the tendency of the curl so that the curl of the original can be detected accurately.

The above embodiment has been described with respect to the case where the operator manually turns the original over when the original is judged being loaded in reverse. However, it is possible to provide an automatic reversing device in order to turn the original over automatically. It is also possible to provide both manual and automatic modes so that either of them can be selected.

In the above embodiment, the CCD image sensor is used, and the partial focusing positions, which are positions of the image-forming lens at which the focusing regions are respectively focused, are detected based on the contrast values of the image formed on the photoreceptive surface of the CCD image sensor. However, it is possible to use, for instance, an optical distance sensor that has a light emitting unit and a light receiving unit and measures distance to an object by using triangulation, instead of using the CCD image sensor.

The above embodiment has been described with respect to the case where the front surface from the rear surface of the original is distinguished by inspecting the curl of the original. However, some originals have prerecorded information, such as a bar code, a frame number or the like, on their front surfaces. For such originals, it is possible to distinguish the front surface from the rear surface by detecting the prerecorded information. In this case, it is possible to distinguish between the front and rear surfaces with high precision by a combination of the inspection of the curl of the original and the detection of the prerecorded information.

Besides a long slender 35 mm photographic film, the present invention can be applied to a slide-mounted film. The slide-mounted film tends to curl to be bowl-shaped.

Although the present invention has been described with respect to the preferred embodiment, the present invention is not to be limited to the above embodiment but, on the contrary, various modifications will be possible to those skilled in the art without departing from the scope of claims appended hereto.

What is claimed is:

1. An image reading apparatus for reading an image from an original loaded in a film carrier, by focusing said image on a photoreceptive surface of a photoelectric converter by an image-forming lens, said original having a reading side which is one side of a base with said image recorded thereon, said image reading apparatus comprising:
a partial focusing position detector for performing focus detection for each of focusing regions provided in a image reading area on said original so as to detect positions of said image-forming lens where said focusing regions are focused as partial focusing positions; and
a loading condition judgment unit for judging whether said original is loaded in said film carrier properly, with said reading side facing said photoreceptive surface, by inspecting curl of said photographic film based on said partial focusing positions.

2. An image reading apparatus as claimed in claim 1, wherein said image reading is not executed when said loading condition judgment unit judges said original not being loaded in said carrier properly, with said reading side facing said photoreceptive surface.

3. An image reading apparatus as claimed in claim 1, further comprising an annunciator, said annunciator giving warning when said loading condition judgment unit judges said original not being loaded in said carrier properly, with said reading side facing said photoreceptive surface.

4. An image reading apparatus as claimed in claim 3, wherein said annunciator includes a display for displaying a warning message.

5. An image reading apparatus as claimed in claim 1, wherein said loading condition judgment unit judges said original being loaded properly when said image reading area is bowed such that the center thereof is concave downward from a side of said photoreceptive surface, whereas said loading condition judgment unit judges said original not being loaded properly when said image reading area is bowed such that the center thereof projects toward said photoreceptive surface.

6. An image reading apparatus as claimed in claim 1, wherein said focusing regions include at least two regions that are close to and far from an optical axis of said image-forming lens.

7. An image reading apparatus as claimed in claim 1, wherein said image reading area has a rectangular shape, and said focusing regions include at least three regions that are a center region of said image reading area and a pair of edge regions that are symmetric with respect to said center region and being located at opposite corners of said image reading area.
